(19) United States
(12) Patent Application Publication
(10) Pub. No.: US 2011/0288226 A1
(43) Pub. Date: Nov. 24, 2011

(54) Compounded masterbatch for carrying flame retardant materials and processer for preparing

(76) Inventors: Veerag Mehta, Middlesex, NJ (US); David Romenesko, Midland, MI (US)

(21) Appl. No.: 13/068,705

(22) Filed: May 18, 2011

Related U.S. Application Data
(60) Provisional application No. 61/395,997, filed on May 20, 2010.

(51) Int. Cl. C08L 83/04; B02C 19/00

(52) U.S. Cl. 524/506; 524/500; 241/30

(57) ABSTRACT

Compounded masterbatch compositions for carrying fire retardant materials and novel processes for preparing such masterbatch compositions.

The application claims priority from U.S. Provisional patent application Ser. No. 61/395,997, filed May 20, 2010.

The present invention deals with compounded masterbatch compositions for carrying fire retardant materials and novel processes for preparing such masterbatch compositions. For purposes of this invention, “fire retardancy” and “flame retardancy” are considered essentially equivalent.

### BACKGROUND OF THE INVENTION

Plastic materials utilized in today's engineering world have greatly increased in demand. These materials have been used in such applications as various components for automobiles, machines home and office furniture, airplane components and the like.

Some of these plastics are not strong enough for some of these applications and considerable effort has been devoted toward the improvement of mechanical properties such as improvements in impact strength.

In recent years, the engineers have turned their attention to fire retardancy of these plastics and various systems and schemes have been proposed for providing fire retardancy within cost parameters.

### THE INVENTION

Thus, there is provided in this invention a one-step process for producing a compounded masterbatch for carrying fire retardant materials. The process comprises combining concurrently the incipient materials a silicone polymer, silica, and a carrier polymer selected from the group consisting essentially of thermoplastic polymers, thermoset prepolymers, rubber, thermoplastic prepolymers, oligomers of thermoplastic polymers, and, oligomers of thermoset polymers.

Thereafter, the incipient materials are masticated until the masticated material has a mean particle size of 100 microns or less. The ratio of the combined components silicone polymer and silica to the carrier polymer is 0.5 to 99.5% to 99.5 to 0.5%.

There is a second embodiment that is the process as set forth above wherein, in addition, there is a fire retardant component added to the incipient materials prior to mastication.

There is yet another embodiment of this invention which is the addition of an adjuvant, that is, a silane, to the incipient materials prior to mastication.

Still another embodiment of this invention is the addition of an adjuvant, that is, a siloxane treating polymer, to the incipient materials prior to mastication.

Another embodiment of this invention is the addition of two adjuvants, that is, a silane, and a siloxane treating polymer, to the incipient materials prior to mastication.

### BRIEF DESCRIPTION OF THE DRAWINGS

FIG. 1 is a cumulative representation of data associated with the use of antimony trioxide in flame retardant compositions.

FIG. 2 is a chart of the results of using polyethylene with a brominated fire retardant carried out on extruded sheet and compared to a system also containing antimony trioxide in the same extruded product using ASTM E84 testing.

### DETAILED DESCRIPTION OF THE INVENTION

The present invention therefore relates to a one-step process for producing a compounded masterbatch for carrying fire retardant materials. The process comprises combining concurrently the incipient materials including a silicone polymer, silica, and a carrier polymer selected from the group consisting essentially of thermoplastic polymers, thermoset prepolymers, rubber, thermoplastic prepolymers, oligomers of thermoplastic polymers, and, oligomers of thermoset polymers.

The masticated masterbatch itself, provides fire retardant properties without the inclusion of known fire retardants typically used in such similar formulations.

Carrier polymers include those selected from the group consisting essentially of thermoplastic polymers, thermoset prepolymers, rubber, thermoplastic prepolymers, oligomers of thermoplastic polymers, and, oligomers of thermoset polymers.

Thermosetting polymers and prepolymers, thermoplastic polymers and prepolymers, oligomers of thermoplastic and thermoset polymers, and rubbers of this invention are well known in the art and may be homopolymers or copolymers. As noted Supra, such materials may be thermoplastic or thermoset polymers, or rubbers and such materials can be for example polyphenylene ether, polystyrene, high impact polystyrene, polycarbonate, polypropylene, or the like. Examples of other thermoplastics are polysulfones, poly(phenylene sulfide), acrylonitrile-butadiene-styrene copolymers, nylons, acetal, polyethylene and copolymers thereof, polyethylene terephthalate, poly(butylene terephthalate), acrylics, fluoroplastics, and thermoplastic polyesters, among others.

Examples of thermosetting polymers which can be modified with the incipient materials of this invention include, for example, phenolics, epoxies, urethanes, unsaturated polyesters, polyimides, melamine formaldehyde, urea, and the like.

Preferred materials include, for example, Acrylonitrile butadiene styrene (ABS), polybutylene terephthalate (PBT), polyethylene terephthalate (PET), polypropylene (PP), polyethylene (PE), ethylene vinyl acetate 9EVA), thermoplastic polyurethane (TPU), styrene acrylonitrile (SAN), high impact polystyrene (HIPS), polyvinyl chloride (PVC), styrene ethylene butylene styrene (SEBS), ethylene propylene diene monomer (EPDM) rubber, natural rubber, nitrile rubber, nylon 5 (polyamide 5) and Nylon 66.

The siloxane polymer of the incipient materials is a high consistency polymer. The polymer is preferred to have at least one type of functional group in the molecule, such a hydroxy, or vinyl, or the like.

Such siloxane polymers are preferred to have organic groups independently selected from hydrocarbon or halogenated hydrocarbon radicals such as alkyl and substituted alkyl radicals containing from 1 to 20 carbon atoms; alkenyl radicals, such as vinyl and 5-hexenyl; cycloalkyl radicals, such as cyclohexyl; and aromatic hydrocarbon radicals such as phenyl, benzyl or tolyl. Such materials are prepared by well-known methods, such as the acid or base catalyzed polymerization of cyclic diorganosiloxanes.

The silica of the incipient materials is a finely divided filler derived from fume, precipitated or mined forms of silica. These silicas are typically characterized by surface areas greater than about 50 m²/gm. The fume form of silica is preferred to be a reinforcing filler based on the surface area, which can be as high as 900 m²/gm, but preferably has a surface area of 50 to 400 m²/gm.

For purposes of this invention, the silica can be, optionally treated with a silane, a siloxane treating polymer, or a combination of a silane and a siloxane treating polymer.

Such siloxane treating polymers can be, for example, low molecular weight liquid hydroxy- or alkoxy-terminated polydiorganosiloxanes, hexaorganodisiloxanes and hexaorganodisilazanes. The silicon bonded hydrocarbon radicals in all or a portion of these materials may contain substituents such as carbon-carbon double bonds, or the like.

As set forth Supra, the masticated incipient materials provide fire retardancy without the use of traditional fire retardants, but fire retardants can be used herein. It should be noted that the materials of this invention can be used without fire retardant synergists, such as antimony compounds, for example, antimony oxide which is well-known and used in most all halogen-based fire retardant compositions.

Further, other significant improvements in properties of these inventive materials are: improved impact strength, tensile, elongation, Melt Flow Index (MFI), Limiting oxygen index (LOI), low smoke evolution, lower heat release rates, and lower carbon monoxide rates.

Still further, additional ingredients can be added to the compositions of the present invention. These additional ingredients include but are not limited to extending fillers such as quartz, calcium carbonate, and diatomaceous earths, pigments, electrically conducting fillers, heat stabilizers, fire retardants such as halogenated hydrocarbons, alumina trihydrate, magnesium hydroxide, organophosphorous compounds, metaborates, such as calcium metaborate, such as Bulab®Flamebloc 428 manufactured by Buckman Performance Chemicals, Memphis, Tenn., and other fire retardant materials.

The amounts of incipient materials are used such that the ratio of the combination of the siloxane polymer and the silica to the carrier polymer is 0.5 to 99.5 weight % to 99.5 to 0.5 weight %. Preferred for this invention are ratios of 85/30 to 15/70 and most preferred are ratios of 40/60 to 60/40.

The process of this invention is a one-step process whereby all of the incipient ingredients are added concurrently to a high intensity twin screw extruder to produce a masterbatch.

It is also contemplated within the scope of this invention to use other available equipment for manufacturing, such as Farrel Continuous Mixers, Buss Co-Kneaders, High mixing single screw extruders, two roll mills, Banbury mixers, paddle mixers, and the like.

The product from this process can be in emulsion form, solution form, or pellets or particles. It is preferred within the scope of this invention to provide particles having average sizes of 100 microns or less, and most preferred for this invention are particles having an average particle size of about 20 microns or less.

It was noted Supra, that this invention provides materials having fire retardancy without the use of fire retardants and also without the use of antimony oxide as a synergist.

Decabromodiphenyl oxide is essentially a solid having a melting point of greater than 300° C. and a boiling point of about 425° C.

Antimony trioxide has no flame retardant function itself, however, when it is used together with halogenated fire retardants, the synergistic effect of the mixture creates flame retardant properties. Antimony trioxide reacts with halogenated compounds and creates the chemical compounds that generate the flame retardant function by stopping the action of thermal decomposition char reaction under gas phase (the radical trap effect); sealing action against oxygen under gas phase (the sealing effect); and the formation of carbonaceous char under the solid phase (the air sealing and adiabatic effect).

Such reactions are the following:

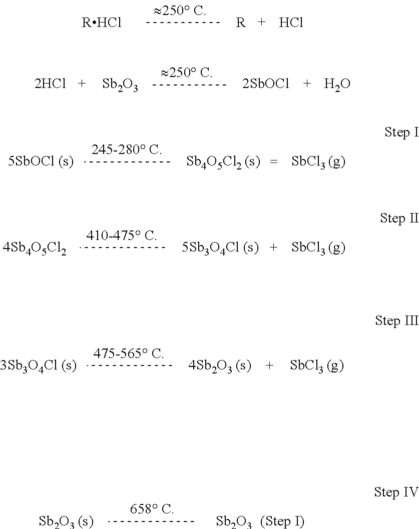

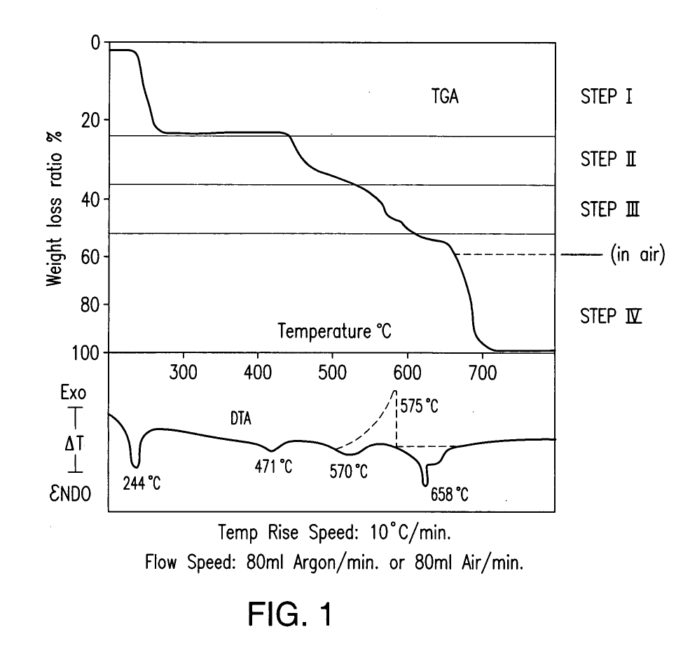

The cumulative representation of this data can be found in FIG. 1.

In a similar manner, both silicon and antimony are metalloids having electrically conductive surfaces. Both silicon and antimony are very compatible with halogens such as chlorine and bromine as both create metalloid halogen based materials. These oxides thus act in a similar manner.

The key is to have the siloxane polymer and silica intimately dispersed with the halogen fire retardant materials to allow electrical contact and synergy for the free radical trap that bromine and chlorine provide in the flame cone. Since antimony trioxide is a solid, and since most halogenated fire retardants are solids, intimate connection between the two is difficult but improved by rendering them into very small particle sizes.

With siloxane polymer/silica systems, the surface active features of siloxane polymer will coat the solid halogenated materials thus providing the intimate contact that is required. The siloxane polymer brings along the silica as well, which is a synergist itself.

The siloxane polymer, in a fire, becomes silica and they will work together to move the free radical to trap the bromine or chlorine. Silica itself will do this but the combination of siloxane and silica is more effective due to the surface properties of the silicone.

This summary of the preferred mechanism is that the siloxane polymer plus silica in small particle sizes has the capability to coat the halogen fire retardant material and thus provide first intimate interaction with the halogen fire retardant in the flame but also improves physical properties of the carrier polymer by coating the halogen fire retardant.

These improved physical properties give the “in use” benefits and the improved fire retardant synergy to provide the catastrophic benefits.

### EXAMPLES

The materials used in the following examples were Petrothene, a polyethylene thermoplastic purchased from Lyondell Basell, Houston, Tex.; Fireshield H, 1.0 to 1.8 micron antimony oxide was purchased from Chemtura, Philadelphia, Pa.; Rhodasil 759, a silicone vinyl based gum was purchased from Blue Star Silicones, East Brunswick, N.J.; Zeothix 265, 1.7 micron precipitated silica was purchased from J. M. Huber, Edison, N.J.; Saytex BT93W, ethylenebistetrabromo-phthalimide was purchased from Albemarle, Baton Rouge La.; DE-83R is 3.5 to 4 micron decabromodiphenyloxide purchased from Chemtura, POS75, al mg silicate purchased from Tech Nano, purchased from Nanocor Inc. Hoffman Estates, Ill., BP66, brominated polystyrene at 66 to 68% purchased from Technick Products, Patterson, N.J., and Capron 8202NL was purchased from Honeywell, Phoenix, Ariz.

### Example 1

### Manufacture of Polypropylene Masterbatch

A material of this invention was prepared wherein there was present 1.17 weight % methacrylate functional silane, 37.83 weight percent silica, and 61% silicone gum.

All masterbatches are prepared at 60% gum and two passes are required to compound. The material was compounded on a GP11 screw. The powders were added via a side feeder after the polymers were melted.

The material in this invention was made in two steps. The first step requires the absorption of a methacrylate functional silane onto silica. Using a Waring blender, 97 wt. % Zeothix 265 and 3% DynaSylan MEMO were poured into the Waring blender and allowed to mix for 3 minutes at the highest RPM setting. The silane and silica blend was then used in the next part.

In the second step, a ZSK 25 mm twin screw extruder with 10 barrels was heated up to 230° C. with a side feeder connected in Zone 4 of the extruder. The screw in the machine was configured so that plastic polymer pellets can be fed in the feed throat, and melted by the end of zone 3 so the silica/silane blend can be introduced in Zone 4. Using two loss in weight feeders, 3.4 wt. % Fina 3866 polypropylene and 73.2 wt. % EverGlide MB150 (50% Silicone UHMW in Polypropylene masterbatch) was fed into the feed throat. (EverGlide MB150 is the tradename associated with the products of this invention) Then 23.4 wt. % silica/silane blend from step 1 was added in Zone 4 via the side feeder. The process was set for 15 lb./hr. with the main screw running at 500 RPM. The final product yielded 40% polypropylene, 0.7 wt. % DynaSylan MEMO, 22.7 wt. % silica, and 36.6% ultrahigh molecular weight (UMW) siloxane.

### Example 2

### Manufacture of a Compound

The material in this invention can be prepared in two steps. The first step required the absorption of a methacrylate functional silane onto silica. Using a Waring blender, 97 wt. % Zeothix 265 and 3% DynaSylan MEMO were poured into the Waring blender and allowed to mix for 3 minutes at the highest RPM setting. The silane and silica blend was then used in the next step.

In the second step, a ZSK 25 mm twin screw extruder with 10 barrels was heated to 190 C with a side feeder connected in Zone 4. The screw in the machine was configured so that plastic polymer pellets can be fed in the feed throat, and melted by the end of zone 3 so the silica/silane/flame retardant blend can be introduced in Zone 4. The process temperature was set at 190 C.

The extruder was set at 400 RPM, and the production rate was at 50 lb./hr. The formulation was as follows:

| | |
|---|---|
| 15% | Saytex BT93W |
| 1.98% | Silica/Silane Blend |
| 6.04% | EverGlide MB350 (50% UHMW Siloxane in PE) |
| 76.98% | Westlake EMAC SP1307 |

In consolidating these steps, the step of making precursor flame retardant of this invention can be avoided.

### Example 3

A preparation of low density polyethylene, with high melt flow index was made wherein the amount of low density polyethylene (Petrothene) was balanced compared to the other materials, for example, run 2 has 68% Petrothene.

The compounding temperature was 210° C.; screw RPM=500; rate: 25 lb/hr; total barrels=10; GP11 screw. Injection molding conditions: temperatures 380 F/390 F/400 F/400 F; pressure=500 psi; rate=50%, and mold temperature=110 F.

The results are shown on Table I infra.

TABLE I

| | | % Deca Brom | | % invent. |
|---|---|---|---|---|
| Run# | Base Resin | DE83R | Sb₂O₃ | active |
| 1 | Petrothene | 0 | 0 | 0 |
| | NA204000 | | | |
| 2 | ″ | 24 | 8 | 0 |
| 3 | ″ | 24 | 0 | 3 |
| 4 | ″ | 24 | 0 | 5 |
| 5 | ″ | 24 | 0 | 8 |

| | | | Tensile @ | Elongation @ | Tensile @ | Elong @ |
|---|---|---|---|---|---|---|
| Run# | LOI | MFI | Yield (psi) | Yield % | Break (psi) | break % |
| 1 | <20 | 8.00 | 1921 | 13.7 | 1253 | >300 |
| 2 | 30 | 4.70 | 1379 | 11.8 | 1043 | 123 |
| 3 | 25 | 8.30 | 1709 | 12.9 | 1305 | 248 |
| 4 | 29 | 8.60 | 1728 | 13.3 | 1369 | >300 |
| 5 | 21 | 9.00 | 1572 | 15.1 | 1186 | >300 |

### Example 4

### Sheet Compounding for E84 Testing

The material prepared in Example 3 was then converted into a thin sheet composite. Using the compound prepared in Example 3, the resin was dried at 140 F for 4 hours, and then fed into a 2.5″ Egan/Davis Standard sheet extrusion line. The sheet line had five temperature zone and three die zones in order to make a 24″ wide film. The temperatures were set as follows: Zone 1—370 F, Zone 2—450 F, Zone 3—470 F, Zone 4—485 F, Zone 5—500 F. All transfer pipes lines and adapters were set at 500 F, and the die was set at 510 F. This allowed for a melt temp of 490-500 F.

The material was processed so that the melt temperature was maintained in the range of 490-500 F. The film was extruded to a thickness of 30 mils. The die was vertically mounted, so that it was extruding downwards with gravity. A second unwind roll was there so that as the sheet extruded, it was coated onto aluminum foil as it was then being cooled before being wound up.

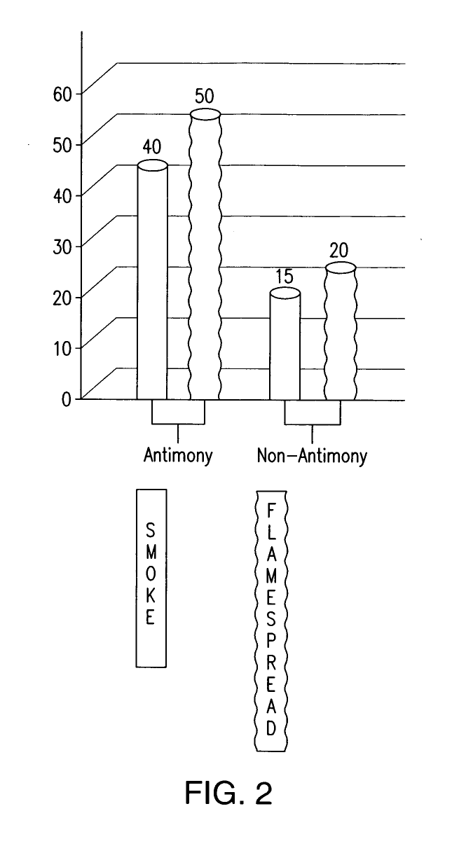

This film then had the edges trimmed, and was submitted for testing as per ASTM E84 which tests for flame spread and smoke index. The lab results that returned showed a flame spread of 20 and smoke index of 15. The results are shown in FIG. 2.

### Example 5

A second batch of materials was prepared using Alathon MX4621, a polyethylene purchased from Lyondell Basell. All of the other ingredients are identified in Examples Supra.

The compounding temperature was 220° C.; screw RPM=450/30; rate=lb/hr.; total barrels=10. Injection molding conditions were temperatures=380 F/390 F/400 F/400 F; pressure=500 psi; rate=50%, and Molding temperature was 110° F. The results are in TABLE II.

TABLE II

| Run | Base | % Saytex | % | % | | |
|---|---|---|---|---|---|---|
| # | Resin | BT93W | Sb₂O₃ | active | LOI | |
| 1 | Alathon | 8 | 3 | 0 | <20 | control |
| | MX4621 | | | | | |
| 2 | ″ | 8 | 3 | 3 | 22 | |
| 3 | ″ | 8 | 3 | 5 | 21 | |
| 4 | ″ | 8 | 0 | 5 | 20.5 | |
| 5 | ″ | 8 | 0 | 3 | 21.5 | |

| | | Tensile @ | | Tensile @ | | Notched |
|---|---|---|---|---|---|---|
| | | Yield | Elongation @ | break | Elongation @ | Izod |
| Run# | MFI | (psi) | Yield (%) | (psi) | break (%) | (ft-lb/in) |
| 1 | 3.14 | 2715 | 15.6 | 1776 | >500 | 1 |
| 2 | 3.08 | 2565 | 15.7 | 1637 | >504 | 0.913 |
| 3 | 3.30 | 2490 | 15.5 | 1750 | >505 | 0.957 |
| 4 | 3.14 | 2540 | 15.8 | 1470 | >506 | 0.913 |
| 6 | 3.02 | 2561 | 16.0 | 1780 | >507 | 0.963 |

### Example 6

### Injection Molding for Physical Property Testing Including LOI

Samples were prepared by the method described in example 2 with the formulas below and then molded and tested for physical properties. HDPE Samples were compounded on a 25 mm twin screw extruder. The twin screw extruder was set at 220 C and 450 RPM.

In the feed throat, Alathon MB4621 (HDPE) was added along with EverGlide MB250H. In the side feeder, the silane/silica blend, antimony trioxide, and Saytex BT93W were blended together depending on the formulation. The powders were all fed downstream in Zone 4 of the extruder after the polymer had melted. The materials were all run as per the following Table III.

TABLE III

| | | % Saytex | | % DynaSil |
|---|---|---|---|---|
| Run # | Base Resin | BT93W | % Antimony | FR260 |
| 1 | Alathon MX4621 | 8 | 3 | 0 |
| 2 | Alathon MX4621 | 8 | 3 | 5 |
| 3 | Alathon MX4621 | 8 | 0 | 5 |

Once the samples were compounded, they were dried at 140 F and then molded on a 99 ton injection molding machine. The molding machine is made by Boy USA (Exton, Pa.). The samples were injection molded with the following profile: Zone 1—380 F, Zone 2—390 F, Zone 3—400 F, and Nozzle—400 F. The mold temp was 110 F. Samples were then tested by ASTM standards of D638 (tensile), D790 (Flex), D256 (impact), D2863 (LOI) and D1238 (MFI). The results of the tests are TABLE IV.

TABLE IV

| | | | | | | | Notched |
|---|---|---|---|---|---|---|---|
| | | | Tensile @ | Elongation @ | Tensile @ | Elongation @ | Izod |
| Run # | LOI | MFI | Yield (psi) | Yield (%) | Break (psi) | Break (%) | (ft-lb/in) |
| 1 | <20 | 3.14 | 2715 | 15.6 | 1776 | >500 | 1 |
| 2 | 22 | 3.08 | 2565 | 15.7 | 1637 | >504 | 0.913 |
| 3 | 21.5 | 3.02 | 2561 | 16.0 | 1780 | >507 | 0.963 |

### Example 7

A third batch of materials was compounded using Capron 8202NL from Honeywell. Capron 8202NL is Nylon 6.

The compounding temperature=250° C.; screw RPM=450; rate=30 lb/hr; total barrels=10. Injection molding conditions were temperatures=460 F/475 F/490 F/490 F; pressure=500 psi; rate=50%, and the molding temperature was 180° F. The results can be found on TABLE V.

TABLE V

| Run# | Base Resin | % BP66 | % antimony | % 4-7081 | % active |
|---|---|---|---|---|---|
| 1 | Capron 8202NL | 18 | 3 | 0 | 0 |
| 2 | ″ | 18 | 0 | 3 | 0 |
| 3 | ″ | 18 | 0 | 5 | 0 |
| 4 | ″ | 18 | 0 | 0 | 3 |
| 5 | ″ | 18 | 0 | 0 | 5 |
| 6 | ″ | 18 | 0 | 0 | 3 |

| | | | Tensile @ | Elonga. @ | Tensile @ | Elonga. @ |
|---|---|---|---|---|---|---|
| Run# | UL-94 | MFI | Yield (psi) | Yield (%) | Break (psi) | Break (%) |
| 1 | V-2 | 20.26 | 9992 | 6.3 | 6015 | 22.8 |
| 2 | V-2 | 16.64 | 9560 | 6.3 | 6626 | 14.6 |
| 3 | V-2 | 17.78 | 9066 | 6.3 | 6356 | 19.1 |
| 4 | V-2 | 21.26 | 9148 | 6.3 | 5820 | 27.8 |
| 5 | V-2 | 19.04 | 9123 | 6.3 | 5891 | 22.9 |
| 6 | V-2 | 19.04 | 9983 | 6.3 | 8405 | 12.7 |

### Example 8

A material was manufactured containing polyethylene, siloxane polymer, silica, and fire retardant according to this invention using only a single pass MB. A second material was prepared by a prior art process and contained the same fire retardant and also, antimony trioxide.

Once the samples were compounded, they were dried at 140 F and then molded on a 99 ton injection molding machine. The molding machine is made by Boy USA (Exton, Pa.). The samples were injection molded with the following profile: Zone 1—380 F, Zone 2—390 F, Zone 3—400 F, and Nozzle—400 F. The mold temp was 110 F. Samples were then tested by ASTM standards of D638 (tensile), D790 (Flex), D256 (impact), D2863 (LOI) and D1238 (MFI). The results of the tests are shown on TABLE VI.

TABLE VI

| | | | PE w/FR & | PE w/FR & |
|---|---|---|---|---|
| | | | 5% product | 8.3% product |
| Property | PE Control | PE with FR | FR 460 | FR 460 |
| Tensile | 1900 | 1379 | 1700 | 1730 |
| Elongation | >300 | 123 | >300 | >300 |
| Melt Flow | 8 | 4.7 | 8.3 | 8.6 |
| LOI | >20 | 30 | 29 | 31 |

### Example 9

### Use of Si Powders for Injection Molding and Physical Property Testing Including UL-94

Samples were prepared as the method described in Example 2 with the formulas below and then molded and tested for physical properties. Samples were compounded on a 25 mm twin screw extruder. The twin screw extruder was set at 250 C and 450 RPM.

In the feed throat, Capron 8202NL (PA6) was added along with EverGlide MB1950. In one of the runs, instead of silica, a nano sodium silicate was used. Also, in this example, no silane was treated on the silica or silicate. In the side feeder, the silica blend, silicate, antimony trioxide, and FlameCheck BP66 were blended together depending on the formulation. The powders were all fed downstream in Zone 4 of the extruder after the polymer had melted. The materials were all run as shown on TABLE VII.

TABLE VII

| | | | | % | |
|---|---|---|---|---|---|
| | Base | | % | DynaSil | W/Nano |
| Run# | Resin | % BP66 | Antimony | FR1960 | silicate? |
| 1 | Capron | 18 | 3 | 0 | N |
| | 8202NL | | | | |
| 2 | Capron | 18 | 0 | 8.3 | N |
| | 8202NL | | | | |
| 3 | Capron | 18 | 0 | 8.3 | Y |
| | 8202NL | | | | |

Once the samples were compounded, they were dried at 180 F and then molded on a 99 ton injection molding machine. The molding machine is made by Boy USA (Exton, Pa.). The samples were injection molded with the following profile: Zone 1—460 F, Zone 2—475 F, Zone 3—490 F, and Nozzle—490 F. The mold temp was 180 F. Samples were then tested by ASTM standards of D638 (tensile), D790 (Flex), D256 (impact), and UL94. The results of the tests are shown on TABLE VIII.

TABLE VIII

| | | | Tensile | Elongation | Tensile | Elongation |
|---|---|---|---|---|---|---|
| | | | @ Yield | @ Yield | @ Break | @ Break |
| Run# | UL-94 | MFI | (psi) | (%) | (psi) | (%) |
| 1 | V-2 | 20.26 | 9992 | 6.3 | 6015 | 22.8 |
| 2 | V-2 | 19.04 | 9123 | 6.3 | 5891 | 22.9 |
| 3 | V-2 | 19.04 | 9983 | 6.2 | 8405 | 12.7 |

What is claimed is:

1. A one-step process for producing a compounded masterbatch for carrying fire retardant materials, the process comprising:
A. combining concurrently the incipient materials:
i. a silicone polymer,
ii. silica,
iii. a carrier polymer selected from the group consisting essentially of
a. thermoplastic polymers,
b. thermoset prepolymers,
c. rubbers,
d. thermoplastic prepolymers,
e. oligomers of thermoplastic polymers, and,
f. oligomers of thermoset polymers;
B. masticating the incipient materials until the masticated material has a mean particle size of 100 microns or less, wherein the ratio of components i. and ii. to the carrier polymer is 0.5 to 99.5% to 99.5 to 0.5%.

2. The process as claimed in claim 1 wherein, in addition, there is a fire retardant component added to the incipient materials.

3. The process as claimed in claim 1 wherein, in addition, there is added a hydrolyzable silane to the incipient materials.

4. The process as claimed in claim 1 wherein, in addition, there is added a treating hydroxy endblocked polydimethylsiloxane to the incipient materials.

5. The process as claimed in claim 1 wherein, in addition, there is added a combination of a treating hydroxy endblocked polydimethylsiloxane and a hydrolyzable silane to the incipient materials.

6. The process as claimed in claim 1 wherein the carrier polymer is a thermoset prepolymer.

7. The process as claimed in claim 1 wherein the carrier polymer is a thermoplastic rigid polymer.

8. The process as claimed in claim 1 wherein the carrier polymer is a thermoplastic flexible polymer.

9. A process as claimed in claim 3 wherein, in addition, there is present, a fire retardant material.

10. A process as claimed in claim 4 wherein, in addition, there is present, a fire retardant material.

11. A process as claimed in claim 5 wherein, in addition, there is present, a fire retardant material.

12. A composition of matter that is manufactured by the process of claim 1.

13. A composition of matter that is manufactured by the process of claim 2.

14. A composition of matter that is manufactured by the process of claim 3.

15. A composition of matter that is manufactured by the process of claim 4.

16. A composition of matter that is manufactured by the process of claim 5.

17. A composition of matter that is manufactured by the process of claim 9.

18. A composition of matter that is manufactured by the process of claim 10.

19. A composition of matter that is manufactured by the process of claim 11.

20. A process as claimed in claim 1 wherein the incipient materials are masticated until they have a mean particle size of 20 microns or less.
